(19) United States
(12) Patent Application Publication
(10) Pub. No.: US 2020/0167730 A1
(43) Pub. Date: May 28, 2020

(54) PARAMETRIC CATASTROPHE INSURANCE TOOL

(71) Applicant: HAREDS PTY LTD, Brisbane (AU)

(72) Inventor: Karen Lesley Hardy, Brisbane (AU)

(21) Appl. No.: 16/613,029

(22) PCT Filed: Aug. 3, 2017
(86) PCT No.: PCT/AU2017/050813

§ 371 Date: Nov. 12, 2019

(30) Foreign Application Priority Data
Jun. 5, 2017 (AU) 2017100655

(51) Int. Cl. G06Q 10/10; G06Q 40/08

(52) U.S. Cl. CPC G06Q 10/10; G06Q 50/26; G06Q 40/08

(57) ABSTRACT

The present invention relates to a parametric catastrophe insurance method. The method including the steps of electronically automated: Receiving of an Application including submission of verifiable documentation by the applicant, Calculation of Premium based on location and coverage limit sought, applicant Premium Payment and Retrieval of insurance documentation by the policy holder confirming placement of cover for an insurance policy covering a catastrophe in a geographic region. The method includes the step of electronically confirming settlement to the policy owner responsive to the catastrophe for that geographic region. Advantageously, the claim settlement is confirmed responsive to the catastrophe being declared in the geographic region so that settlement can be made immediately without the need for the policy holder lodging a claim or an assessor performing an assessment and settlement to occur, which otherwise introduces undesirable delay.

### TECHNICAL FIELD

The present invention relates to the application of parametric insurance triggered by a “Declared Catastrophe” for the immediate financial benefit of policy holders (individuals, commercial and rural enterprises) within the declared area. “Catastrophe” is defined as a Declared Natural Disaster by the relevant Government Authority and includes such perils as Fire, Tsunami, Earthquake, Cyclone or Flood.

### BACKGROUND

The reference to any prior art in this specification is not, and should not be taken as an acknowledgement or any form of suggestion that the prior art forms part of the common general knowledge.

Natural disasters such as cyclone, fire, flood, tsunami and earthquake are devastating to the economic wellbeing of communities within the affected regions. These disasters are becoming more prevalent and severe due to global warming whilst Government welfare assistance becomes unsustainable.

Although, many are insured against such events, via traditional insurance products, the reality is that settlement may take years to receive and finalise. The immediate financial hardship incurred by a “catastrophe” is not relieved by traditional insurance policies where Material Damage must be determined, assessed and quantified by industry professionals. In reality, the shortage of qualified insurance industry assessors and experienced claims staff can cause massive delays in the insurance process. Moreover, the logistics of mounting a recovery plan is often delayed by the material damage caused by the natural disaster and the intervention of government agencies. Currently, there is no automatic or immediate financial assistance provided by any party in the aftermath of a Declared Natural Disaster.

The preferred embodiment provides parametric catastrophe insurance technology to quicken settlement to policy holders affected by and in a catastrophe.

### SUMMARY OF THE INVENTION

According to the present invention, there is provided a Parametric Catastrophe Insurance method including the steps of electronically automated: Receiving an application including submission of verifiable documentation by the applicant, Calculation of Premium based on location and coverage limit sought, Applicant payment and Retrieval of insurance documentation confirming placement of cover by the policy holder. This electronically automated system will extract the required policy holder details upon declaration of “Catastrophe” and submit required details to the insurer for their immediate payment by Electronic Funds Transfer into policy holder's nominated account.

Advantageously, the Claim Settlement is confirmed responsive to the “Catastrophe” being declared in the geographic region so that Claim Settlement can be made automatically and immediately to the policy holder without the need to lodge a claim or wait for an assessment which otherwise introduces undesirable delay.

The method may involve electronically validating the application. The method may receiving a declaration of the catastrophe. The declaration may be received from the government.

The application may include a postcode or Shire of the geographic region. The step of confirming settlement will be passed upon the postcode and/or shire provided by the applicant and verified supporting documentation. The step of requesting settlement may involve sending a payment request to an insurance company, financial institution or other party that makes payment in a predefined file format.

According to another aspect of the present invention, there is provided a Parametric Catastrophe Insurance tool configured to electronically: Receive, from an applicant (individual, commercial or rural enterprise), an Application for an insurance policy covering a catastrophe in a geographical region; and Confirm settlement to the policy owner responsive to the catastrophe for that geographic region.

According to another aspect of the present invention, there is provided a Parametric Catastrophe Insurance system including the tool, in turn, including a server hosting a website.

The system may further include an applicant's computer connected to the website so that the applicant can personally prepare and complete the application.

The system may further include the relevant government agency for declaring the “catastrophe” within their state or territory.

The system may further include an Insurer or underwriter for settlement/payment of claims.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic drawing of a parametric catastrophe insurance system in accordance with an embodiment of the present invention;

FIG. 2 is a flow chart of a parametric catastrophe insurance method performed using the system in FIG. 1 in perpetual cycle; and

FIG. 3 shows an automated application with criteria for an insurance policy created using the system of FIG. 1.

### DETAILED DESCRIPTION OF PREFERRED EMBODIMENTS

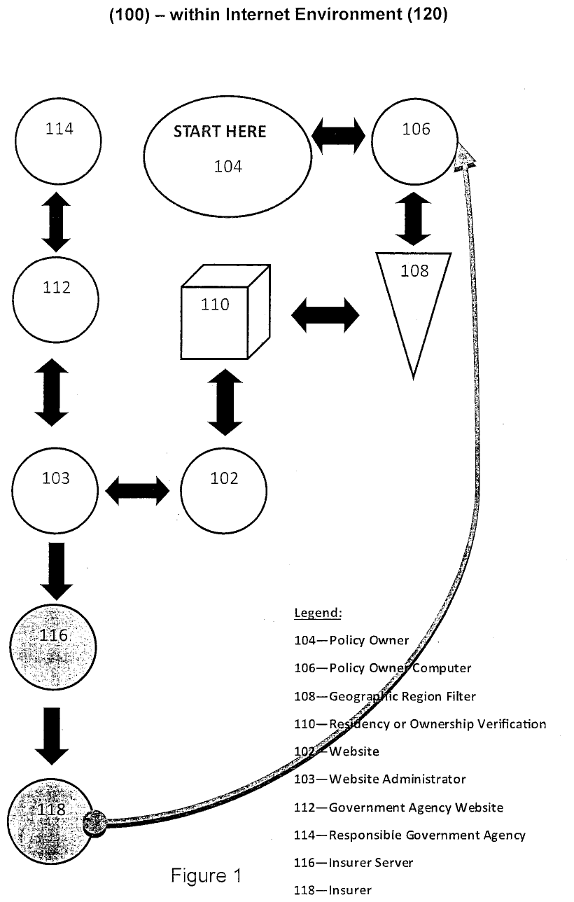

According to an embodiment of the present invention, there is provided a parametric catastrophe insurance system 100 as shown in FIG. 1. The System 100 includes an administration server 102 hosting a website (i.e. a tool). The server 102 is maintained by a system administrator 103.

The Parametric Catastrophe Insurance server 102 is configured to electronically receive, from an applicant 104 using a computer 106, an application for an insurance policy covering a catastrophe (e.g. cyclone) 108 in a geographic region. Typically, the coverage would be dependent upon proof of ownership of eligible asset or residency 110 in the geographic region. The server 102 also confirms remittance of claim settlement to the policy holder 104 responsive to the catastrophe 108 being declared for that region in which the policy owner 104 resides or owns eligible assets.

Advantageously, the claim settlement is confirmed responsive to the catastrophe 108 being declared in the geographic region so that settlement can be made immediately without the need for the policy holder 104 lodging a claim or an assessor performing an assessment and settlement to occur, which otherwise introduces undesirable delay.

The applicant's computer 106 is connected to the website so that the applicant 104 can prepare the application. The system 100 further includes a government agency server 112 for reporting the catastrophe 108 declared by the government 114. Furthermore, the system 100 includes an insurer/underwriter server 116 for the making of the approved electronic settlement from the insurer/underwriter 118 to the policy holder 104.

Each of the computers 106 and servers 102, 112, 116 communicate via network 120 including the Internet.

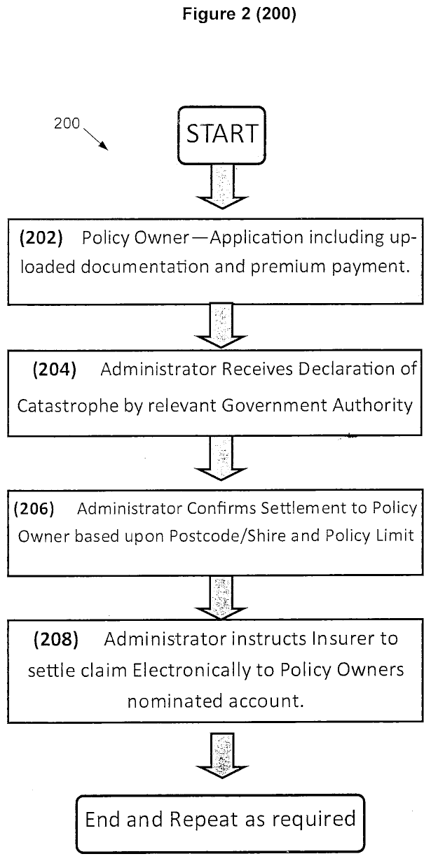

A parametric catastrophe insurance method 200 is now described with reference to FIG. 2.

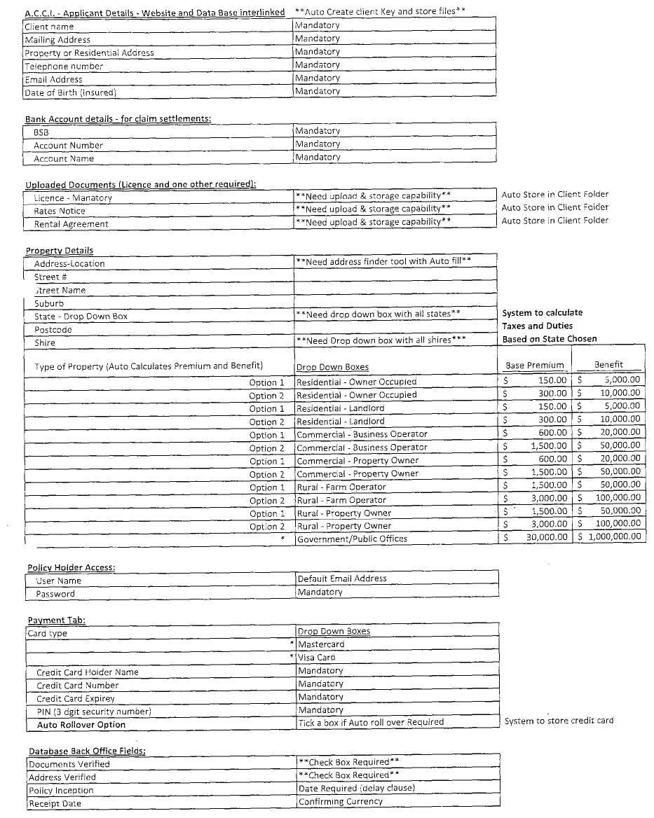

At step 202, the administration server 102 receives, from the applicant 104, an application for a parametric insurance policy covering a catastrophe 108 in a geographic region in which the applicants eligible assets or residence 110 are located. The server 102 automatically validates and calculates the application as criteria is entered as shown, for example, in FIG. 3. The application includes a postcode and Shire of the geographic region 108.

At step 204, the administrator 103 receives via the administration server 102, from the relevant government agency server 112, notification of a catastrophe declaration event issued by the Government 114 including the affected geographical regions.

At step 206, the administrator 103 confirms via the administration server 102 settlements to the applicant responsive to the catastrophe being declared for the geographic region for which the applicants' policy is held. In particular, the settlement is confirmed based upon the postcode and shire by the applicant 104 that matches a postcode and shire of the geographic regions which are the subject of the catastrophe declaration.

At step 208, the administrator 103 sends a payment instruction via the administration server 102 to the insurer/underwriter server 116 or other party that makes the payment. In turn, the insurer/underwriter 118 immediately electronically transfers the settlement to the policy holder 104 so that the catastrophe affected policy holder 104 has immediate access to settlement. In this manner, accommodation, food, alternative power supplies, assistance with clean up, additional staff, stock et cetera may be immediately purchased without the usually delays caused by the traditional insurance assessment process.

A person skilled in the art will appreciate that many embodiments and variations can be made without departing from the ambit of the present invention.

The preferred embodiment involves the government 114 for declaring a catastrophe 108 to imitate settlement. In other embodiments, settlement triggers may include environmental conditions (e.g. flood levels above 100 year event, category 3 cyclones or above, windstorm with a central pressure of 950 HP or below, etc).

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A Parametric Catastrophe Insurance tool configured to electronically:
receive, from an applicant, an application for an insurance policy covering a catastrophe in a geographical region; and
confirm settlement to the applicant responsive to the catastrophe being declared for that geographic region.

2. The Parametric Catastrophe Insurance tool as claimed in claim 1, wherein the settlement is confirmed responsive to the catastrophe being declared for the geographic region so that claim settlement is made automatically and immediately to the applicant without the need to lodge a claim or wait for an assessment which otherwise introduces undesirable delay.

3. The Parametric Catastrophe Insurance system including the tool of claim 1, in turn, including a server hosting a website.

4. The Parametric Catastrophe Insurance system of claim 3, further including an applicant's computer connected to the website so that the applicant can personally prepare and complete the application.

5. The Parametric Catastrophe Insurance system of claim 3, further including a government agency for declaring the catastrophe within the geographic region.

6. The Parametric Catastrophe Insurance system of claim 3, further including an insurer or underwriter for settlement or payment of claims.

7. A parametric catastrophe insurance method including electronically automated:
receipt of an application including submission of verifiable documentation by an applicant,
calculating a premium based on location and coverage limit sought, and premium
payment and retrieval of insurance documentation by the applicant confirming placement of cover for an insurance policy covering a catastrophe in a geographic region.

8. The parametric catastrophe insurance method as claimed in claim 7, wherein a claim settlement is confirmed responsive to the catastrophe being declared in the geographic region so that the claim settlement can be made automatically and immediately to the policy holder without the need to lodge a claim or wait for an assessment which otherwise introduces undesirable delay.

9. The parametric catastrophe insurance method as claimed in claim 7, involving receiving a declaration of the catastrophe or environmental conditions which trigger the payment confirmation.

10. The parametric catastrophe insurance method as claimed in claim 7, wherein the application includes a postcode and shire of the geographic region and confirming settlement is based upon the postcode and shire provided by the applicant.

11. The parametric catastrophe insurance method as claimed in claim 7, involving extracting policy details upon declaration of the catastrophe and submitting required details to the insurer for immediate payment by Electronic Funds Transfer into an applicant's nominated account.

12. The parametric catastrophe insurance method as claimed in claim 7, involving electronically validating the application.

13. The parametric catastrophe insurance method as claimed in claim 7, involving receiving a declaration of the catastrophe.

14. The parametric catastrophe insurance method as claimed in claim 13, wherein the declaration is received from the government.

15. The parametric catastrophe insurance method as claimed in claim 7, wherein the application includes a postcode or shire of the geographic region.

16. The parametric catastrophe insurance method as claimed in claim 15, wherein settlement confirmation will be passed using the postcode or shire and is verified using supporting documentation.

17. The parametric catastrophe insurance method as claimed in claim 7, wherein requesting settlement involves sending a payment request to an insurance company, financial institution or other party that makes payment in a predefined file format.
